(19) United States
(12) Patent Application Publication
(10) Pub. No.: US 2025/0192253 A1
(43) Pub. Date: Jun. 12, 2025

(54) SOLID-STATE BATTERY MODULE

(71) Applicant: Murata Manufacturing Co., Ltd., Nagaokakyo-shi (JP)

(72) Inventor: Tomohiro KATO, Nagaokayo-shi (JP)

(21) Appl. No.: 19/040,181

(22) Filed: Jan. 29, 2025

Related U.S. Application Data
(63) Continuation of application No. PCT/JP2023/026428, filed on Jul. 19, 2023.

(30) Foreign Application Priority Data
Aug. 25, 2022 (JP) 2022-134463

(51) Int. Cl. H01M 10/46; H01M 10/0562; H01M 50/298

(52) U.S. Cl. CPC H01M 10/46; H01M 10/0562; H01M 50/298

(57) ABSTRACT

A solid-state battery module including: a first substrate with a wiring; a solid-state battery on the first substrate; and a second substrate on an opposite side of the solid-state battery relative to the first substrate and internally including a coil part that is electrically connectable to the first substrate, where a main surface of the second substrate defines a module top surface or is inside the module top surface.

### CROSS REFERENCE TO RELATED APPLICATIONS

The present application is a continuation of International application No. PCT/JP2023/026428, filed Jul. 19, 2023, which claims priority to Japanese Patent Application No. 2022-134463, filed Aug. 25, 2022, the entire contents of each of which are incorporated herein by reference.

### TECHNICAL FIELD

The present disclosure relates to a solid-state battery module. More specifically, the present disclosure relates to a solid-state battery modularized such that the battery can be mounted on a substrate.

### BACKGROUND ART

Conventionally, secondary batteries that can be repeatedly charged and discharged have been used for various applications. For example, secondary batteries are used as power sources of electronic devices such as smartphones and notebooks. In a secondary battery, a liquid electrolyte is commonly used as a medium for ion transfer that contributes to charging and discharging. More specifically, a so-called electrolytic solution is used for the secondary battery. However, in such a secondary battery, safety is commonly required in terms of preventing leakage of the electrolytic solution. In addition, because an organic solvent and the like for use in the electrolytic solution are flammable substances, safety is required in that respect as well.

Thus, solid-state batteries in which a solid electrolyte is used instead of an electrolytic solution have been studied. The solid-state battery includes a battery element including a positive electrode layer, a negative electrode layer, and a solid electrolyte interposed between the electrode layers of the positive electrode layer and negative electrode layer.
Patent Document 1: Japanese Patent Application Laid-Open No. 2018-160968

### SUMMARY OF THE DISCLOSURE

The solid-state battery may be used as, for example, a control circuit, a sensor, an antenna, and a wireless power supply circuit for the solid-state batteries, and a solid-state battery module with the control circuit, sensor, antenna, and wireless power supply circuit combined and integrated together.

A solid-state battery module that has a wireless power supply mechanism or a wireless communication mechanism requires a coil part for transmitting and receiving electromagnetic waves. The coil part may be disposed separately from the solid-state battery module. For example, the coil part may be externally disposed on the solid-state battery module. In such a disposing mode, when the coil part is disposed separately from the solid-state battery module, the total size of the solid-state battery module and coil part can be increased. In addition, depending on the position or the like of the coil part separately disposed with the location of the solid-state battery module as a benchmark, the coil part varies in inductance value, and matching is required for each solid-state battery module. From the foregoing, in an aspect in which the coil part is disposed separately from the solid-state battery module, it is difficult to say that wireless power supply or the like is efficiently performed.

The present disclosure has been made in view of such problems. More specifically, an object of the present disclosure is to provide a solid-state battery module that allows efficient wireless power supply and the like to be efficiently performed.

The present disclosure provides a solid-state battery module including: a first substrate with a wiring; a solid-state battery on the first substrate; and a second substrate on an opposite side of the solid-state battery relative to the first substrate and internally including a coil part that is electrically connectable to the first substrate, where a main surface of the second substrate defines a module top surface or is inside the module top surface.

The solid-state battery module according to the present disclosure allows wireless power supply and the like to be efficiently performed.

### BRIEF EXPLANATION OF THE DRAWINGS

FIG. 1 is a sectional view schematically illustrating the configuration of a solid-state battery module according to an embodiment.

FIG. 2 schematically shows a sectional view of the solid-state battery module of FIG. 1 taken along a side surface 1300.

FIG. 3 is a sectional view schematically illustrating the configuration of a solid-state battery module according to an embodiment.

FIG. 4 schematically shows a sectional view of the solid-state battery module of FIG. 3 taken along a side surface 1300.

FIG. 5 is a plan view schematically illustrating a coil part provided in a solid-state battery module according to an embodiment.

FIG. 6 is a plan view schematically illustrating a coil part provided in a solid-state battery module according to an embodiment.

FIG. 7 is a plan view schematically illustrating a coil part provided in a solid-state battery module according to an embodiment.

FIG. 8 is a sectional view schematically illustrating the configuration of a solid-state battery module according to an embodiment.

FIG. 9 schematically shows a sectional view of the solid-state battery module of FIG. 8 taken along a side surface 1300.

FIG. 10 is a sectional view schematically illustrating the bottom surface of a solid-state battery module according to an embodiment.

FIG. 11A is a step sectional view schematically illustrating a step in a method for manufacturing a solid-state battery module according to an embodiment of the present disclosure.

FIG. 11B is a step sectional view schematically illustrating a step in a method for manufacturing a solid-state battery module according to an embodiment of the present disclosure.

FIG. 11C is a step sectional view schematically illustrating a step in a method for manufacturing a solid-state battery module according to an embodiment of the present disclosure.

FIG. 11D is a step sectional view schematically illustrating a step in a method for manufacturing a solid-state battery module according to an embodiment of the present disclosure.

FIG. 11E is a step sectional view schematically illustrating a step in a method for manufacturing a solid-state battery module according to an embodiment of the present disclosure.

FIG. 11F is a step sectional view schematically illustrating a step in a method for manufacturing a solid-state battery module according to an embodiment of the present disclosure.

### DESCRIPTION OF THE PREFERRED EMBODIMENTS

Hereinafter, a solid-state battery module according to an embodiment of the present disclosure will be described in detail. Although the description will be made with reference to the drawings as necessary, the illustrated contents are only schematically and exemplarily illustrated for the understanding of the present disclosure, and the appearance, the dimensional ratio, or the like may be different from the actual ones.

The “solid-state battery module” as used in the present description refers in a broad sense to a composite device including a plurality of components including a solid-state battery, and in a narrow sense to a composite device including a solid-state battery, a circuit element, a circuit connecting them, and a substrate.

The “sectional view” as used in the present description is based on a form (briefly, a form in the case of being cut along a plane parallel to the layer thickness direction) viewed from a direction substantially perpendicular to the stacking direction in the stacked structure of the solid-state battery. In addition, the “plan view” used in the present description is based on a sketch drawing when an object is viewed from an upper side or a lower side along the layer thickness direction (that is, the stacking direction mentioned above).

The “vertical direction” and “horizontal direction” used directly or indirectly in the present description correspond to a vertical direction and a horizontal direction in the drawings, respectively. Unless otherwise specified, the same reference signs or symbols shall denote the same members or sites or the same meanings. In a preferred aspect, it can be understood that a downward direction in a vertical direction (that is, a direction in which gravity acts) corresponds to a “downward direction”/a “bottom surface side”, and the opposite direction thereof corresponds to an “upward direction”/a “top surface side”.

The “solid-state battery” referred to in the present disclosure refers to a battery with the constituent elements being solid in a broad sense, and refers to an all-solid-state battery with all constituent elements being solid in a narrow sense. In a preferred aspect, the solid-state battery in the present disclosure is a stacked solid-state battery configured such that layers constituting a battery constituent unit are stacked on each other, and such layers are preferably made of fired bodies. The “solid-state battery” encompasses not only a so-called “secondary battery” that can be repeatedly charged and discharged but also a “primary battery” that can only be discharged. According to a preferred aspect of the present disclosure, the “solid-state battery” is a secondary battery. The “secondary battery” is not excessively restricted by its name, which can encompass, for example, a power storage device and the like. In the present disclosure, the solid-state battery included in the module can also be referred to as a “solid-state battery element”.

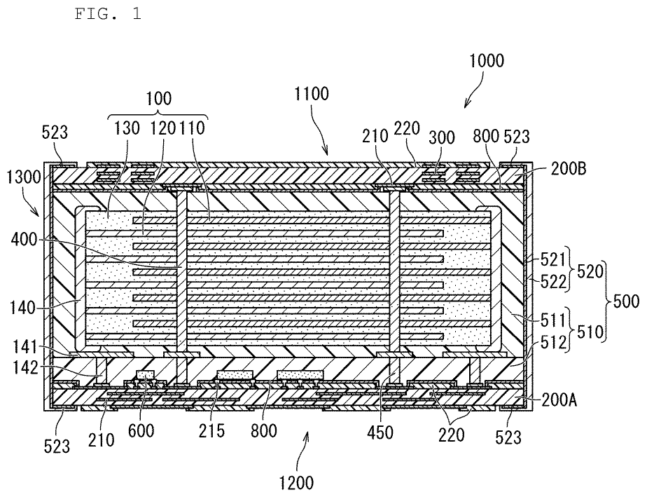

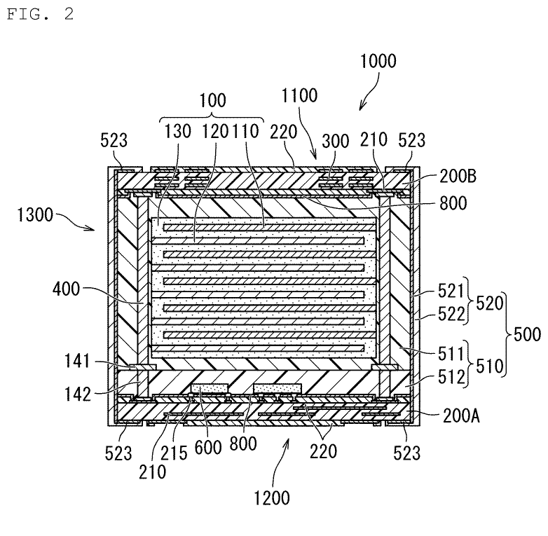

FIG. 1 is a sectional view schematically illustrating the configuration of a modularized solid-state battery according to an embodiment of the present disclosure. FIG. 2 schematically shows a sectional view of the solid-state battery module of FIG. 1 taken along a side surface 1300.

### [Basic Configuration of Solid-State Battery]

The basic configuration of the solid-state battery 100 will be first described below. The configuration of the solid-state battery described herein is merely an example for understanding the disclosure, and not considered limiting the disclosure. The solid-state battery 100 includes at least electrode layers: a positive electrode and a negative electrode, and a solid electrolyte. Specifically, the solid-state battery 100 has a battery element including a battery constituent unit including a positive electrode layer 110, a negative electrode layer 120, and a solid electrolyte 130 at least interposed therebetween.

For the solid-state battery 100, each of the layers that are constituent elements for the solid-state battery may be formed by firing, and the positive electrode layer, the negative electrode layer, the solid electrolyte, and the like may form fired layers. Preferably, the positive electrode layer, the negative electrode layer, and the solid electrolyte are fired integrally with each other, and thus, the battery element preferably forms an integrally fired body.

The positive electrode layer is an electrode layer including at least a positive electrode active material. The positive electrode layer may further include a solid electrolyte. In a preferred aspect, the positive electrode layer may be composed of a fired body including at least positive electrode active material particles and a solid electrolyte. In contrast, the negative electrode layer is an electrode layer containing at least a negative electrode active material. The negative electrode layer may further include a solid electrolyte. In a preferred aspect, the negative electrode layer may be composed of a sintered body including at least negative electrode active material particles and a solid electrolyte.

The positive electrode active material and the negative electrode active material are substances involved in the transfer of electrons in the solid-state battery. Ions move (conduct) between the positive electrode layer and the negative electrode layer through the solid electrolyte to transfer electrons, thereby charging and discharging the battery. Each electrode layer of the positive electrode layer and the negative electrode layer is preferably a layer capable of occluding and releasing lithium ions or sodium ions, in particular. More specifically, the solid-state battery is preferably an all-solid-state secondary battery in which lithium ions or sodium ions move between the positive electrode layer and the negative electrode layer through the solid electrolyte, thereby charging and discharging the battery.

### (Positive Electrode Active Material)

Examples of the positive electrode active material included in the positive electrode layer include at least one type selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compounds that have an olivine-type structure include Li₃Fe₂(PO₄)₃, LiFePO₄, and/or LiMnPO₄. Examples of the lithium-containing layered oxides include LiCoO₂ and/or LiCo_{1/3}Ni_{1/3}Mn_{1/3}O₂. Examples of the lithium-containing oxides that have a spinel-type structure include LiMn₂O₄ and/or LiNi_{0.5}Mn_{1.5}O₄. The types of the lithium compound is not particularly limited, and may be, for example, a lithium-transition metal composite oxide and a lithium-transition metal phosphate compound. The lithium-transition metal composite oxide is a generic term for oxides containing lithium and one or two or more types of transition metal elements as constituent elements, and the lithium transition metal phosphate compound is a generic term for phosphate compounds containing lithium and one or two or more types of transition metal elements as constituent elements. The types of transition metal elements are not particularly limited and are, for example, cobalt (Co), nickel (Ni), manganese (Mn), iron (Fe), and the like.

In addition, examples of positive electrode active materials capable of occluding and releasing sodium ions include at least one selected from the group consisting of sodium-containing phosphate compounds that have a NASICON-type structure, sodium-containing phosphate compounds that have an olivine-type structure, sodium-containing layered oxides, and sodium-containing oxides that have a spinel-type structure. For example, examples thereof include at least one type selected from the group consisting of Na₃V₂(PO₄)₃, NaCoFe₂(PO₄)₃, Na₂Ni₂Fe(PO₄)₃, Na₃Fe₂(PO₄)₃, Na₂FeP₂O₇, and Na₄Fe₃(PO₄)₂(P₂O₇) in the case of sodium-containing phosphate compounds, and NaFeO₂ as a sodium-containing layered oxide.

In addition, the positive electrode active material may be, for example, an oxide, a disulfide, a chalcogenide, a conductive polymer, or the like. The oxide may be, for example, a titanium oxide, a vanadium oxide, a manganese dioxide, or the like. The disulfide is, for example, a titanium disulfide, a molybdenum sulfide, or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, or the like.

### (Negative Electrode Active Material)

Examples of the negative electrode active material included in the negative electrode layer include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li—Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

Further, in the solid-state battery, the positive electrode layer and the negative electrode layer are made of the same material.

The positive electrode layer and/or the negative electrode layer may include a conductive material. Examples of the conductive material included in the positive electrode layer and the negative electrode layer include at least one of metal materials such as silver, palladium, gold, platinum, aluminum, copper, and nickel, and carbon.

Further, the positive electrode layer and/or the negative electrode layer may include a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thicknesses of the positive electrode layer and negative electrode layer are not particularly limited, but may be each independently, for example, 2 μm to 50 μm, particularly 5 μm to 30 μm.

### (Positive Electrode Current Collecting Layer/Negative Electrode Current Collecting Layer)

Although not an essential element for the electrode layer, the positive electrode layer and the negative electrode layer may respectively include a positive electrode current collecting layer and a negative electrode current collecting layer. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing. As the positive electrode current collector constituting the positive electrode current collecting layer and the negative electrode current collector constituting the negative electrode current collector, it is preferable to use a material with a high conductivity, and for example, silver, palladium, gold, platinum, aluminum, copper, and/or nickel may be used. The positive electrode current collector and the negative electrode current collector may each have an electrical connection for being electrically connected to the outside, and may be configured to be electrically connectable to an end-face electrode. It is to be noted that when the positive electrode current collecting layer and the negative electrode current collecting layer have the form of a fired body, the layers may be composed of a fired body including a conductive material and a sintering aid. The conductive materials included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as sintering aids that can be included in the positive electrode layer/the negative electrode layer. As described above, in the solid-state battery, the positive electrode current collecting layer and the negative electrode current collecting layer are not essential, and a solid-state battery provided without such a positive electrode current collecting layer or a negative electrode current collecting layer is also conceivable. More specifically, the solid-state battery included in the package according to the present disclosure may be a solid-state battery without any current collecting layer.

### (Solid Electrolyte)

The solid electrolyte is a material capable of conducting lithium ions or sodium ions. In particular, the solid electrolyte layer that forms the battery constituent unit in the solid-state battery may form a layer capable of conducting lithium ions between the positive electrode layer and the negative electrode layer. It is to be noted that the solid electrolyte layer has only to be provided at least between the positive electrode layer and the negative electrode layer. More specifically, the solid electrolyte layer may be present around the positive electrode layer and/or the negative electrode layer so as to protrude from between the positive electrode layer and the negative electrode layer. Specific examples of the solid electrolyte included in the solid electrolyte layer include any one, or two or more of a crystalline solid electrolyte, a glass-based solid electrolyte, and a glass ceramic-based solid electrolyte.

Examples of the crystalline solid electrolyte include oxide-based crystal materials and sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors. Examples of the lithium-containing phosphate compounds that have a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). Examples of the lithium-containing phosphate compounds that have a NASICON structure include Li_{1.2}Al_{0.2}Ti_{1.8}(PO₄)₃. An example of the oxides that have a perovskite structure includes La_{0.55}Li_{0.35}TiO₃. An example of the oxides that have a garnet-type or garnet-type similar structure include Li₇La₃Zr₂O₁₂. In addition, examples of the sulfide-based crystal materials include thio-LISICON, for example, Li_{3.25}Ge_{0.25}P_{0.75}S₄ and Li₁₀GeP₂S₁₂. The crystalline solid electrolyte may include a polymer material (for example, a polyethylene oxide (PEO)).

Examples of the glass-based solid electrolyte include oxide-based glass materials and sulfide-based glass materials. Examples of the oxide-based glass materials include 50Li₄SiO₄-50Li₃BO₃. In addition, examples of the sulfide-based glass materials include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials and sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In addition, examples of the sulfide-based glass ceramic materials include Li₇P₃S₁₁ and Li_{3.25}P_{0.95}S₄.

In addition, examples of the solid electrolyte capable of conducting sodium ions include sodium-containing phosphate compounds that have a NASICON structure, oxides that have a perovskite structure, and oxides that have a garnet-type or garnet-type similar structure. Examples of the sodium-containing phosphate compounds that have a NASICON structure include NaₓM_{y}(PO₄)₃ (1≤x≤2, 1≤y≤2, and M is at least one selected from the group consisting of Ti, Ge, Al, Ga, and Zr).

The solid electrolyte layer may include a sintering aid. The sintering aid included in the solid electrolyte layer may be selected from, for example, the same materials as the sintering aids that can be included in the positive electrode layer or the negative electrode layer.

The thickness of the solid electrolyte layer is not particularly limited. The thickness of the solid electrolyte layer located between the positive electrode layer and the negative electrode layer may be, for example, 1 μm to 15 μm, particularly 1 μm to 5 μm.

### (End-Face Electrode)

The solid-state battery is typically provided with end-face electrodes 140. In particular, the solid-state battery have side surfaces provided with end-face electrodes 140. More specifically, the side surfaces are provided with a positive-electrode-side end-face electrode connected to the positive electrode layer and a negative-electrode-side end-face electrode connected to the negative electrode layer (see FIG. 1). Such end-face electrodes preferably contain a material with a high conductivity. The specific material of the end-face electrodes is not particularly limited, but examples thereof can include at least one selected from the group consisting of silver, gold, platinum, aluminum, copper, tin, and nickel.

### (Covering Part)

The solid-state battery module may include a covering part that covers the solid-state battery. The covering part is a layer that covers at least the periphery of the solid-state battery. As shown in FIGS. 1 and 2, the solid-state battery 100 may be largely enclosed as a whole by a covering part 500. In other words, the solid-state battery 100 may be covered with the covering part 500 so as to be surrounded as a whole.

The covering part covers the solid-state battery, so as to shield the solid-state battery from the external environment. Thus, degradation of the battery characteristics due to water vapor (more specifically, a phenomenon of degradation of the characteristics of the solid-state battery due to mixture of water vapor in the external environment) can be further suppressed. It is to be noted that the term “water vapor” as used in the present description is not particularly limited to water in a gaseous state, and also encompasses water in a liquid state and the like. More specifically, the term “water vapor” is used to broadly include matters related to water regardless of the physical state. Accordingly, the “water vapor” can also be referred to as moisture or the like, and in particular, as the water in the liquid state, dew condensation water obtained by condensation of water in a gaseous state can also be encompassed.

The covering part may include a covering insulating layer and a covering inorganic layer located outside the covering insulating layer. For example, as shown in FIGS. 1 and 2, a covering insulating layer 510 may be provided so as to cover the solid-state battery 100 and electronic components 600 on a first substrate. In other words, the solid-state battery 100 and the electronic components 600 may be largely enclosed as a whole by the covering insulating layer 510. The covering inorganic layer 520 may be positioned on the relatively distal side from the solid-state battery 100 relative to the covering insulating layer 510. In other words, the covering inorganic layer 520 may be provided so as to cover the covering insulating layer 510. The covering inorganic layer 520 is positioned outside the covering insulating layer 510, and thus has the form of covering the periphery of the solid-state battery 100 together with the covering insulating layer 510.

### (Covering Insulating Layer)

The covering insulating layer may be any type as long as the layer exhibits an insulating property. For example, the covering insulating layer preferably corresponds to a resin layer. More specifically, the covering insulating layer includes a resin, which preferably constitutes a base material of the layer.

The material of the covering insulating layer may be any type as long as the material exhibits an insulating property. For example, the covering insulating layer may include a resin, and the resin may be either a thermosetting resin or a thermoplastic resin. The covering insulating layer may include an inorganic filler. By way of example only, the covering insulating layer may be made of an epoxy-based resin containing an inorganic filler such as SiC, SiO₂, or SiN. The resistivity of the covering insulating layer may be, for example, 10⁶ Ω·cm or more.

### (Covering Inorganic Layer)

The covering inorganic layer may have, for example, a film form. Furthermore, the covering inorganic layer may have the form of also covering the side surface of the substrate. The covering insulating layer forms a preferred water vapor barrier in cooperation with the covering inorganic layer, and the covering inorganic layer also forms a preferred water vapor in cooperation with the covering insulating layer.

The term “barrier” as used in the present description means having a property of blocking water vapor transmission such that no water vapor in the external environment passes through the substrate to cause disadvantageous characteristic degradation for the solid-state battery, and in a narrow sense, means that the water vapor transmission rate is less than 5×10⁻³ g/(m²·Day). In short, the water vapor barrier layer preferably has a water vapor transmission rate of 0 or more and less than 5×10⁻³ g/(m²·Day).

The material of the covering inorganic layer is not particularly limited, and may be metal, glass, oxide ceramics, a mixture thereof, or the like. In a preferred embodiment, the covering inorganic layer contains a metal component. The thickness of the covering inorganic layer may be 0.1 μm to 100 μm, and may be, for example, 1 μm to 50 μm.

### (Metal Pad)

From the viewpoint of further strengthening the bonding between the covering inorganic layer and the substrate, a metal pad may be interposed between the covering part and the substrate. For example, as shown in FIG. 1, a metal pad 523 may be provided on a first substrate 200A and on a second substrate 200B, and the covering inorganic layer 520 may be provided so as to reach the metal pad 523. Such a metal pad 523 may be, as shown in FIG. 1, provided on, for example, the peripheral edges on the bottom surface side of the first substrate 200A and on the top surface side of the second substrate 200B. In particular, when the substrates are made of a ceramic or the like, providing a metal pad is preferred.

### [Characteristic Parts of the Present Disclosure]

Hereinafter, characteristic parts of the present disclosure will be described. The description will be made with reference to the drawings. The illustrated contents are only schematically and exemplarily shown for understanding of the present disclosure, and the appearances, dimensional ratios, and the like can be different from actual ones. In the respective drawings, members that have the same functions may be denoted by the same reference numerals. In the embodiments described later, descriptions of matters that in common with those described above may be omitted, and only differences may be described. In addition, the various embodiments described later may be implemented in any combination, and the present disclosure is not limited to only the embodiments described in the present application.

As shown in FIGS. 1 and 2, a solid-state battery module 1000 according to an embodiment includes the first substrate 200A with a wiring, the solid-state battery 100 disposed on the first substrate 200A, and the second substrate 200B disposed above the solid-state battery 100 and internally including a coil part 300 that is electrically connectable to the first substrate 200A, and the top surface of the second substrate 200B is positioned along the module top surface or inside the module top surface. The second substrate 200B internally including the coil part 300 that is electrically connectable to the first substrate is disposed on the opposite side of the solid-state battery 100 from the first substrate 200A.

For the solid-state battery module 1000 shown in FIGS. 1 and 2, the first substrate 200A, the solid-state battery 100, and the second substrate 200B are disposed in this order. The coil part 300 is provided inside the second substrate 200B. When the coil part 300 receives a magnetic field, an induced current is generated in the coil part 300. The induced current flows to the solid-state battery 100 through the first substrate 200A with the wiring electrically connected to the coil part 300, thereby charging the solid-state battery 100. The solid-state battery module 1000 can be mounted on a mounting substrate with the first substrate 200A interposed therebetween. Further, in the present description, an alternating magnetic field generated by alternating current may be referred to simply as a “magnetic field”.

The module top surface means a module outer surface on the top surface side of the solid-state battery module, from among module outer surfaces that form the outer contour of the solid-state battery module. Referring to FIGS. 1 and 2, the main surface of the solid-state battery module 1000, which is relatively proximal to the second substrate 200B, is the top surface 1100 of the solid-state battery module. In the present description, the top surface 1100 of the solid-state battery module is also referred to simply as a module top surface 1100. On the other hand, the main surface of the solid-state battery module 1000, which is relatively proximal to the first substrate 200A, is the bottom surface 1200 of the solid-state battery module. The surface connecting the top surface 1100 of the solid-state battery module and the bottom surface 1200 of the solid-state battery module is the side surface 1300 of the solid-state battery module. In the present description, the side surface 1300 of the solid-state battery module is also referred to simply as a module side surface 1300. The solid-state battery module 1000 can be mounted on a mounting substrate with the first substrate 200A interposed therebetween, the bottom surface 1200 of the solid-state battery module can also be referred to as a mounting surface.

The phrase “the top surface of the second substrate 200B along the module top surface” means that the top surface of the second substrate 200B and the module top surface are located coplanar with each other. Specifically, of the main surfaces of the second substrate, the main surface relatively distal from the solid-state battery, and the module top surface are located coplanar with each other. Further, the top surface of the second substrate 200B means, of the main surfaces of the second substrate, the main surface on the proximal side with respect to the module top surface side.

In the aspect illustrated in FIGS. 1 and 2, the top surface of the second substrate 200B internally including the coil part 300 is disposed inside the module top surface 1100. The phrase “inside the module top surface” means a direction from the module top surface 1100 toward the inside of the solid-state battery module 1000 (for example, the solid-state battery 100).

In accordance with the aspect mentioned above, the solid-state battery module according to the present disclosure can achieve the following effects.

A solid-state battery module that has a wireless power supply mechanism or a wireless communication mechanism requires a coil part for transmitting and receiving electromagnetic waves. The coil part may be disposed separately from the solid-state battery module. For example, the coil part may be externally disposed on the solid-state battery module. When the coil part is disposed separately from the solid-state battery module, the total size of the solid-state battery module and coil part can be increased.

In the solid-state battery module according to the present disclosure, the coil part is positioned inside the second substrate. The top surface of the second substrate internally including the coil part is positioned along the module top surface or inside the module top surface. The module top surface is an outer surface of the solid-state battery module, which forms the outer contour of the solid-state battery module. Accordingly, the top surface of the second substrate including the coil part is positioned coplanar with the outer surface of the solid-state battery module or inside the outer surface of the solid-state battery module. More specifically, the coil part is disposed inside the solid-state battery module. The disposition of the coil part required no location for disposing the coil part separately from the solid-state battery module, and thus, the total size of the solid-state battery module the coil part can be reduced.

While the coil part has an intrinsic inductance value, the inductance value of the coil part can be affected by another component provided in the solid-state battery module. For example, the wiring itself provided in the solid-state battery module can have an intrinsic inductance value. The inductance value of the coil part connected to the wiring can be a combined inductance value with an inductance value that is intrinsic to the wiring, and thus can vary from the inductance value that is intrinsic to the coil part. In addition, the changed positional relationship between the coil part and the other component included in the solid-state battery module changes the length between the coil part and the other component that can be connected to the coil part, and thus, the inductance value of the coil part can be changed.

In the case of the conventional solid-state battery module, the coil part may be disposed separately from the solid-state battery module, and thus, the location of the coil part may be changed for each solid-state battery module. For example, for the conventional solid-state battery module, the coil part may be provided relatively more proximally or distally from the solid-state battery module. For this reason, in the case of the conventional solid-state battery module, it is difficult to stabilize the inductance value of the coil for each solid-state battery module. Accordingly, in wireless power supply for the solid-state battery module, matching is required for each solid-state battery module.

The solid-state battery module according to the present disclosure internally has the coil part, the location of the coil part can be fixed. The location of the coil part can be fixed, thus making it easier to set the distance between the coil part and another component included in the solid-state battery module to a predetermined distance. More specifically, the inductance value of the coil part for each solid-state battery module is more easily stabilized. When the inductance value is easily stabilized, the matching of the LC frequency with the use of the coil part and a capacitor is more easily performed in wireless power supply, thereby making it easier to charge the solid-state battery module efficiently.

The solid-state battery module according to the present disclosure can further employ the following aspects.

### (Magnetic Body Layer)

When the solid-state battery module is disposed under an alternating magnetic field environment, an induced current can be generated in the coil part provided in the solid-state battery module. The alternating magnetic field can also be absorbed by components constituting the solid-state battery module, besides the coil part. For example, the solid-state battery module according to the present disclosure includes the covering part that covers the solid-state battery, and the covering part can absorb an alternating magnetic field from the outside more than the other components, because the covering part is the outermost layer of the solid-state battery module. In particular, when the covering part contains a metal component, the alternating magnetic field from the outside is more likely to be absorbed by the covering part than the coil part. Accordingly, the alternating magnetic field may be less likely to be transmitted to the coil part.

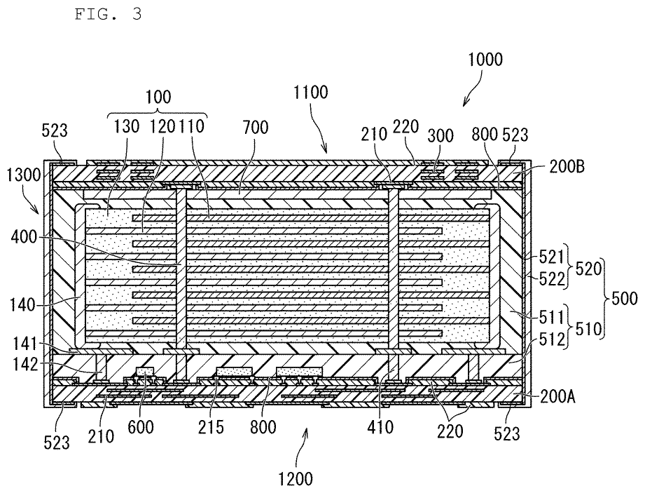

From the viewpoint of more easily transmitting the magnetic field to the coil part, a magnetic body layer may be provided between the solid-state battery and the second substrate in an embodiment. In other words, a magnetic body layer may be provided between the solid-state battery and the coil part. In the aspect shown in FIGS. 3 and 4, a magnetic body layer 700 is provided below the second substrate 200B. The magnetic body layer 700 is relatively higher in magnetic permeability than the other components constituting the solid-state battery module, and thus, can act as a magnetic path for a magnetic flux passing through the coil part 300. Providing the magnetic body layer 700 below the second substrate 200B makes the magnetic field from the outside likely to be attracted relatively more to the coil part built in the second substrate 200B above the magnetic body layer 700. More specifically, the magnetic field from the outside is likely to be efficiently converted into an induced current, and the charging efficiency of the solid-state battery can be improved.

From the viewpoint of attracting the magnetic field more to the coil part, the thickness of the magnetic body layer may be 50 μm or more, preferably 75 μm or more, more preferably 100 μm or more, still more preferably 150 μm or more. From the viewpoint of reducing the thickness of the solid-state battery module, the thickness of the magnetic body layer may be 500 μm or less, preferably 400 μm or less, more preferably 300 μm or less, still more preferably 250 μm or less.

The thickness of the magnetic body layer may be larger than the thickness of the electrode layer of the solid-state battery. Specifically, the thickness of the magnetic body layer may be larger than the positive electrode layer or negative electrode layer of the solid-state battery. From the viewpoint of attracting the magnetic field more to the coil part, the thickness the magnetic body layer may be twice or more, preferably three times or more, more preferably five times or more, still more preferably eight times or more as large as that of the positive electrode layer or the negative electrode layer. From the viewpoint of reducing the thickness of the solid-state battery module, the thickness of the magnetic body layer may be 25 times or less, preferably 20 times or less, more preferably 15 times or less, still more preferably 13 times or less.

The magnetic body layer may be, for example, a layer including a magnetic material and a resin. The magnetic material may be included in the magnetic body layer in a particulate form. For the resin, a thermoplastic resin or a thermosetting resin may be used.

As the magnetic material included in the magnetic body layer, a soft magnetic material may be used. For example, iron, silicon steel, permalloy, a sendust alloy, permendur, ferrite, an amorphous magnetic alloy, magnetic stainless steel, or the like may be used for the soft magnetic material. As the ferrite, Ni—Zn—Cu-based ferrite, Mn—Zn-based ferrite, or the like may be used.

At least one selected from the group consisting of a polyamide resin, a polycarbonate resin, a polyphenylene sulfide resin, an aromatic polyether ketone resin, and a thermoplastic polyimide resin may be used as the thermoplastic resin included in the magnetic body layer.

One or more selected from the group consisting of an epoxy resin, a phenol resin, a melamine resin, an unsaturated polyester resin, a silicone resin, and a thermosetting polyimide resin may be used as the thermosetting resin included in the magnetic body layer.

For example, a mixture of the magnetic material and the resin, subjected to rolling to an arbitrary thickness and formed into a plate shape, may be used for the magnetic body layer. Alternatively, a commercially available magnetic body layer including the magnetic material and the resin may be used.

In an embodiment, while the magnetic body layer is provided between the solid-state battery and the coil part, the magnetic body layer may be disposed adjacent to the second substrate side rather than the solid-state battery. Preferably, the magnetic body layer may have contact with the second substrate side. Employing such a mode of disposing the magnetic body layer reduces the distance between the magnetic body layer and the coil part built in the second substrate, thus making the magnetic field from the outside more likely to be attracted to the coil part. More specifically, the magnetic field from the outside is likely to be efficiently converted into an induced current, and the solid-state battery can be charged more efficiently. In the solid-state battery module, the magnetic body layer can be considered as a layer for attracting a magnetic field to the coil part, in that the magnetic body layer attracts the magnetic field from the outside to the coil part as mentioned above.

The magnetic body layer can have a relatively higher magnetic permeability than each of the components constituting the solid-state battery module. Thus, the magnetic field from the outside can be absorbed more by the magnetic body layer than by each of the components constituting the solid-state battery module. In other words, the magnetic body layer can keep the magnetic field from the outside from being absorbed by each of the components constituting the solid-state battery module. In particular, the magnetic body layer can prevent the each of the components containing a metal component from absorbing the magnetic field from the outside. From this point of view, the magnetic body layer can be considered as a layer for keeping a magnetic field from being adsorbed by the metal side.

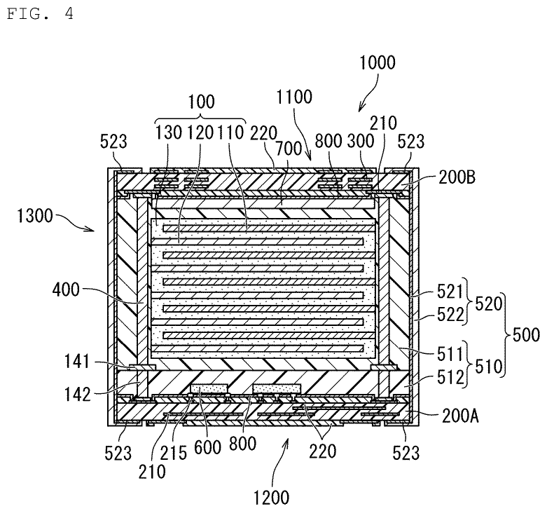

In an embodiment, the coil part may be positioned inside the planar contour of the magnetic body layer. Specifically, the coil part may be positioned inside the region defined by the peripheral edge of the magnetic body layer. In the aspect shown in FIG. 5, while the planar contour of the magnetic body layer 700 is rectangular, the coil part 300 is positioned inside the rectangular planar contour formed by the magnetic body layer 700. Employing such a positional relationship between the magnetic body layer 700 and the coil part 300 makes the magnetic field from the outside, attracted by the magnetic body layer 700, more likely to pass through the whole coil part. More specifically, the magnetic field from the outside is likely to be efficiently converted into an induced current, and the solid-state battery can be charged more efficiently.

The first substrate and second substrate included in the solid-state battery module according to the present disclosure will be described below.

### (First Substrate and Second Substrate)

The solid-state battery module 1000 according to an embodiment includes, as shown in FIG. 1, the first substrate 200A with the wiring, the solid-state battery 100 disposed on the first substrate 200A, and the second substrate 200B disposed on the solid-state battery 100 and internally including the coil part 300 that is electrically connectable to the first substrate 200A.

The first substrate includes the wiring and an electronic component. Specifically, the first substrate has multiple electronic components mounted, and the multiple electronic components are electrically connected to each other by the wiring provided on the first substrate. Each of the multiple electronic components and the wiring provided on the first substrate are fixed with a solder or the like. The first substrate can include a control circuit for controlling the solid-state battery module, which is composed of a wiring and multiple electronic components.

The first substrate may be provided with battery terminal connection pins for electrically connecting the first substrate and the solid-state battery. As shown in FIG. 1, one end of a battery terminal connection pin 142 is connected to the first substrate 200A, and the other end of the battery terminal connection pin 142 is connected to a connection electrode 141. The connection electrode 141 is connected to the end-face electrode 140. The battery terminal connection pin 142 allows transfer of electricity between first substrate 200A and solid-state battery 100.

On the first substrate, a resist layer may be disposed. As shown in FIGS. 1 and 2, a resist layer 220 may be provided, in particular, on the main surfaces of the first substrate 200A. The resist layer 220 is a layer that at least partly covers the substrate surface so as to keep away physical processing or chemical reactions. In the aspect shown in FIG. 1, the resist layer 220 is provided on the first substrate 200A, and the multiple electronic components 600 are provided on the resist layer 220. The resist layer 220 is provided with a wiring 210. The wiring 210 of the resist layer 220 and the electronic component 600 are connected with a solder 215 or the like. The multiple electronic components 600 and the wiring 210 in the first substrate 200A are electrically connected via the wiring 210 in the resist layer 220.

The second substrate includes the coil part. While the coil part is provided in the second substrate, the coil part may have a part provided inside the second substrate and a part exposed on the second substrate. Specifically, the coil part is mainly disposed inside the second substrate, and a part of the coil part is positioned on the upper surface of the second substrate. In other words, a part of the coil part, embedded in the second substrate, is relatively larger than a part exposed on the upper surface of the second substrate. In addition, a part of the coil part is not necessarily required to be positioned on the upper surface of the second substrate, and the whole coil part may be positioned inside the second substrate. As shown in FIGS. 1 and 2, the coil part 300 is connected to the wiring 210 provided on the second substrate 200B. The wiring 210 provided on the second substrate 200B is electrically connected to the first substrate 200A.

The coil part provided in the second substrate may be provided in parallel with the second substrate. For example, the coil part may be provided to be stacked and on the second substrate. For example, like the module top surface 1100 shown in FIG. 5, the coil part 300 may have such a configuration as to draw a spiral in a direction substantially in parallel with the module top surface 1100. The coil part 300 is covered with the resist layer 220 described later, and thus located inside the module top surface 1100.

On the second substrate, a resist layer may be disposed. As shown in FIGS. 1 and 2, the resist layer 220 may be provided, in particular, on the main surfaces of the second substrate 200B. The resist layer 220 is a layer that at least partly covers the substrate surface so as to keep away physical processing or chemical reactions. In the aspect shown in FIG. 1, the resist layer 220 is provided on the second substrate 200B. The resist layer 220 provided on the second substrate 200B serves as an outermost layer of the solid-state battery module 1000, and can constitute at least the module top surface 1100.

For the first substrate and the second substrate, a printed circuit board can be used. The type is not particularly limited, and may be a resin substrate or a ceramic substrate. Further, the type may be a rigid substrate or a flexible substrate. Further, examples of the ceramic substrate include an alumina substrate, an LTCC substrate, and an HTCC substrate. The resin substrate may be manufactured from a material that has a substrate impregnated with a resin. Examples of the substrate include a paper, a glass fiber cloth, and a resin film. The resin may be a thermoplastic resin and/or a thermosetting resin. Examples thereof include a paper phenol substrate that has a paper substrate impregnated with a phenol resin, a paper epoxy substrate that has a paper substrate impregnated with an epoxy resin, a glass epoxy substrate that has a glass fiber cloth impregnated with an epoxy resin, and a flexible substrate in which a polyimide or a polyethylene terephthalate (PET) resin is used. For the wiring provided on the substrate, at least one or more types of metals selected from the group consisting of Cu, Ni, Ag, Au, and Pt may be used.

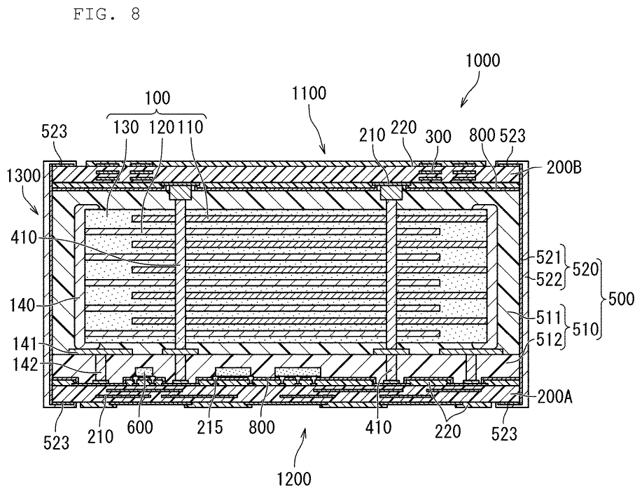

The first substrate preferably serves as a member for electrically connecting the modularized solid-state battery and the outside. More particularly, the substrate can be also considered as a terminal substrate for an external terminal of the solid-state battery. FIG. 10 shows the bottom surface 1200 of the solid-state battery module. The bottom surface 1200 serves as a main surface of the first substrate. As shown in FIG. 10, the first substrate is provided with back surface pads (specifically, metal foils) 211 that can function as external terminals. The solid-state battery module provided with such a substrate allows the solid-state battery can be mounted on another secondary substrate such as a printed wiring board, in such as form with the substrate interposed therebetween. For example, surface mounting can be performed with the use of a solder or a conductive paste. For the reasons described above, the solid-state battery module according to the present disclosure is preferably a surface-mount-device (SMD) type battery module.

Possible aspects of the covering part provided for the solid-state battery module according to the present disclosure will be described below.

In an embodiment, the covering inorganic layer is provided for the solid-state battery module, and the covering inorganic layer may be provided along the side surfaces of the solid-state battery module. In other words, the covering inorganic layer may constitute at least a module side surface part. In the aspect shown in FIGS. 1 and 2, the covering inorganic layer 520 is provided so as to cover each side surface 1300 of the solid-state battery module 1000. Specifically, the covering inorganic layer 520 covers the covering insulating layer 510 covering the periphery of the solid-state battery 100, the side surface of the first substrate, and the side surface of the second substrate. The covering inorganic layer 520 is provided along the side surfaces of the solid-state battery module, and thus, the ingress of water into the solid-state battery module can be further suppressed. For suitably achieving the water vapor barrier of the covering inorganic layer 520, the covering inorganic layer 520 may cover the whole of each side surface 1300 of the solid-state battery module 1000.

In an embodiment, the covering inorganic layer may be provided along the top surface of the solid-state battery module. Specifically, the covering inorganic layer may be provided so as to cover a part of the top surface of the solid-state battery module. In the aspect shown in FIGS. 1 and 2, the covering inorganic layer 520 is provided so as to cover the periphery (or peripheral edge) of the module top surface 1100. The contour profile of the covering inorganic layer 520 covering the module top surface 1100 is a contour profile corresponding to the contour of the module top surface 1100. In the aspect shown in FIG. 5, the contour profile of the covering inorganic layer 520 covering the module top surface 1100 is a rectangular and annular contour shape. The contour profile of the covering inorganic layer 520 covering the module top surface 1100 is rectangular and annular, and thus has an outer contour that forms an outer contour of the “ring” and an inner contour that forms an inner contour of the “ring”. Providing the covering inorganic layer so as to cover a part of the top surface of the solid-state battery module makes the coil part provided inside the second substrate less likely to be covered with the covering inorganic layer. Accordingly, the coil part is more likely to receive the magnetic field from the outside, and the charging efficiency of the solid-state battery can be further improved.

When the aspect in FIGS. 1, 2, and 5 are viewed from another aspect, the covering inorganic layer 520 can be considered including a discontinuous region of the covering inorganic layer 520 on the side with the module top surface 1100. The “discontinuous region” means a region including a part covered with the covering inorganic layer 520 and a part uncovered with the covering inorganic layer 520. For example, on the side with the module side surface 1300 in FIGS. 1, 2, and 5, a continuous region of the covering inorganic layer 520 is formed because the covering inorganic layer 520 covers the whole module side surface 1300. In contrast, on the side with the module top surface 1100, a discontinuous region of the covering inorganic layer is formed because the covering inorganic layer 520 covers not the whole module top surface 1100 but a part of the top surface. In other words, a part of the second substrate 200B can be considered exposed on side with the module top surface 1100. Including the discontinuous region of the covering inorganic layer on the module top surface side makes the coil part provided inside the second substrate less likely to be covered with the covering inorganic layer. Accordingly, the coil part is more likely to receive the magnetic field from the outside, and the charging efficiency of the solid-state battery can be further improved.

In an embodiment, the covering inorganic layer may be provided along the bottom surface of the solid-state battery module. The form of the covering inorganic layer provided on the module bottom surface may have the same form as the form of the covering inorganic layer provided on the module top surface.

In an embodiment, the covering inorganic layer covers the module side surface part, and may constitute a part of at least one of the module top surface and module bottom surface that are continuous with the module side surface part. In the aspect shown in FIG. 1, the covering inorganic layer 520 covering the periphery of the module top surface 1100 is continuous with the covering inorganic layer 520 covering the module side surface 1300. From another point of view, the covering inorganic layer 520 can be considered covering the side surface of the second substrate 200B, and further covering a part of the upper main surface of the second substrate 200B that is continuous with the side surface of the second substrate 200B. Similarly, the covering inorganic layer 520 can be considered covering the side surface of the first substrate 200A, and further covering a part of the upper main surface of the first substrate 200A that is continuous with the side surface of the first substrate 200A. Employing such a configuration makes the coil part 300 more likely to receive the magnetic field from the outside, and thus, the charging efficiency of the solid-state battery 100 can be further improved. In addition, the ingress of water into the solid-state battery module is more easily suppressed.

In an embodiment, in a sectional view, the outer contour of the magnetic body layer may be located on the inner contour of the covering inorganic layer or inside the inner contour. In other words, the outer contour of the magnetic body layer may be overlapped with the inner contour of the covering inorganic layer, or may be located in the region defined by the inner contour of the covering inorganic layer. Specifically, in the aspect shown in FIG. 5, the outer contour of the magnetic body layer 700 is surrounded by the inner contour of the covering inorganic layer 520. In the aspect shown in FIG. 3, a part corresponding to the outer contour of the magnetic body layer 700 in FIG. 5 is located inside a part corresponding to the inner contour of the covering inorganic layer 520 in FIG. 5. More specifically, in the stacking direction of the solid-state battery, the part corresponding to the outer contour of the magnetic body layer 700 and the part corresponding to the inner contour of the covering inorganic layer 520 is not overlapped with each other. Employing such an aspect causes the covering inorganic layer not to be positioned on the magnetic body layer 700, thus making the magnetic field attracted to the magnetic body layer 700 and the magnetic field exiting from the magnetic body layer 700 less likely to be absorbed by the covering inorganic layer. Accordingly, the magnetic field is likely to be efficiently converted into an induced current, and the charging efficiency of the solid-state battery can be improved.

In an embodiment, the planar contour of the magnetic body layer may be surrounded by the covering inorganic layer. Specifically, the covering inorganic layer may be positioned outside the region defined by the peripheral edge of the magnetic body layer. The planar contour of the magnetic body layer means a contour profile observed when the magnetic body layer is viewed in a plan view. In the aspect shown in FIG. 5, while the planar contour of the magnetic body layer 700 is rectangular, the covering inorganic layer 520 is positioned outside the planar contour of the magnetic body layer 700. Employing such a positional relationship between the magnetic body layer 700 and the covering inorganic layer 520 makes the magnetic field from the outside more likely to be attracted to the coil part 300. More specifically, the magnetic field from the outside is likely to be efficiently converted into an induced current, and the solid-state battery can be charged more efficiently.

In an embodiment, the covering insulating layer may include a solid-state battery sealing layer covering the periphery of the solid-state battery and an electronic component sealing layer covering the periphery of the electronic components provided on the substrate. In the aspect shown in FIGS. 1 and 2, the solid-state battery 100 is covered with a solid-state battery sealing layer 511. The electronic components 600 on the first substrate 200A is covered with an electronic component sealing layer 512. The materials of the solid-state battery sealing layer 511 and electronic component sealing layer 512 may be the material of the covering insulating layer exemplified above.

In an embodiment, the covering inorganic layer may include a metal thin film and a metal plating layer. For example, as shown in FIGS. 1 and 2, a metal thin film 521 may be provided so as to have contact with the covering insulating layer 510. A metal plating layer 522 is provided outside the metal thin film 521, in other words, may be positioned on the relatively distal side from the solid-state battery 100 relative to the metal thin film 521.

The metal thin film may be a dry-plating layer, specifically a sputtered film. More specifically, the solid-state battery module according to the present disclosure may be provided with a sputtered film as a metal thin film. The sputtered film is a thin film obtained by sputtering. More particularly, a film obtained by sputtering ions onto a target to eject and then deposit the atoms thereof can be used as the dry-plating layer.

The sputtered film becomes a relatively dense and/or homogeneous film while having a significantly thin nano-order or micro-order form, and thus can contribute to preventing water vapor permeation for the solid-state battery. In addition, the sputtered film is formed by atomic deposition, and can be thus more suitably attached onto the target. Thus, the sputtered film can be more suitably provided as a barrier for preventing water vapor in the external environment from entering the solid-state battery. Thus, the covering inorganic layer further includes the sputtered film as a dry plating layer, thereby allowing the prevention of water vapor permeation to the solid-state battery to be further improved. It is to be noted that the dry plating layer may be formed by another dry plating, such as a vacuum deposition method or an ion plating method. In a preferred aspect, the dry plating layer may contain, for example, at least one selected from the group consisting of Al (aluminum), Cu (copper), Ti (titanium), and stainless steel (SUS).

The thickness of the metal thin film is preferably 1 μm to 10 μm, more preferably 2 μm to 8 μm, still more preferably 3 μm to 6 μm. The thickness of the metal thin film within the range mentioned above can cause the metal thin film to more suitably contribute to preventing water vapor from entering the solid-state battery.

The metal plating layer may be a wet-plating layer. As shown in FIG. 1, the metal plating layer 522 forms the outermost layer of the covering inorganic layer 520. The metal plating layer 522 can be exposed to the external environment, and thus may have alteration resistance. The metal plating layer 522 preferably contains at least one metal selected from the group consisting of nickel (Ni), chromium (Cr), palladium (Pd), platinum (Pt), and Zn.

The thickness of the metal plating layer is preferably 1 μm to 20 μm, more preferably 2 μm to 15 μm, particularly preferably 2 μm to 10 μm. The thickness of the metal plating layer within the range mentioned above can cause alteration of the plating layer to be suitably reduced.

Possible aspects of the wiring provided for the solid-state battery module according to the present disclosure will be described below.

### (Wiring)

In the solid-state battery module according to an embodiment, the first substrate and the coil part are electrically connected to each other. In the aspect shown in FIGS. 1 and 2, the solid-state battery module 1000 further includes connection wirings 400 that connect the first substrate 200A and the coil part 300, thereby electrically connecting the first substrate 200A and the coil part 300. The connection wirings 400 are disposed along the wall surface of the solid-state battery 100. In the aspect of the sectional view of FIG. 1, the connection wirings 400 are provided so as to cross the solid-state battery 100, and the connection wirings 400 are connected to the first substrate 200A via an antenna circuit connection pin 450. Accordingly, the coil part and the solid-state battery are electrically connected via the connection wiring.

Such an arrangement of the connection wirings 400 allows an induced current generated in the coil part 300 to be transmitted to the first substrate 200A. In addition, as shown in FIG. 1, the electronic components 600 are mounted on the main surface of the first substrate 200A, and thus, the induced current generated in the coil part 300 is supplied to the electronic components. In this respect, the coil part 300 and the electronic components 600 are considered electrically connected via the connection wirings 400.

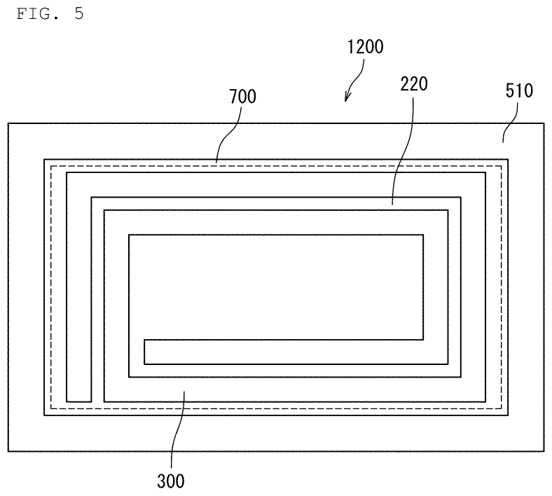

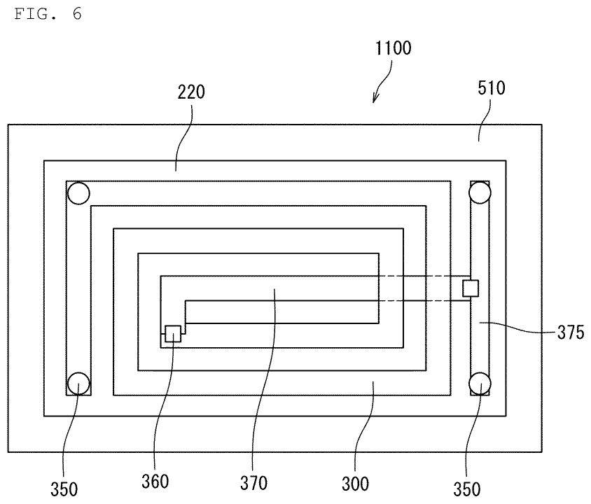

FIG. 6 shows a positional relationship between the coil part 300 and the connection wirings 400 in FIGS. 1 and 2. As mentioned above, the connection wirings 400 connect the first substrate 200A and the coil part 300, and the connection wirings 400 and the coil part 300 are connected via connection pins 350. As shown in FIG. 6, the connection pins 350 are provided on the coil part. The connection wirings 400 are connected to the connection pins 350 (not shown). In the aspect shown in FIG. 6, the four connection pins 350 are provided on the coil part 300, and the coil part 300 is thus provided with the four connection wirings via the connection pins.

Further, the locations of the connection wirings 400 provided for the solid-state battery module 1000 can be changed by changing the locations of the connection pins 350 provided for the coil part 300. Similarly, the number of the connection wirings 400 provided for the solid-state battery module 1000 can be changed by changing the number of the connection pins 350 provided for the coil part 300. For example, as shown in FIG. 8, when the number of the connection pins provided for the coil part 300 is two, the number of the connection wirings provided can be two.

In an embodiment, the coil part and the metal wiring may be connected with a coupling pin to adjust a position where the connection wiring is provided. In the aspects shown in FIGS. 6 and 7, a metal wiring 370 is provided at the tip of the coil part 300. Specifically, the coil part 300 and the metal wiring 370 are fixed with a coupling pin 360. In such an aspect, the coil part 300 can be considered extended by the metal wiring 370. As shown in FIG. 6, the metal wiring 370 may be provided with another metal wiring 375. Connecting the coil part and the metal wiring can be further improved the degree of freedom for the location where the connection wiring is provided.

In an embodiment, the solid-state battery module may be provided with two or more connection wirings. For example, the connection wirings may be provided along only one side surface of the solid-state battery module, or may be provided along two or more side surfaces thereof. For example, one or more connection wirings may be provided along one of the side surfaces.

FIG. 1 shows a sectional view taken along a side surface of the solid-state battery module 1000. In the aspect shown in FIG. 1, two connection wirings 400 are disposed on the side surface of solid-state battery 100. FIG. 2 shows a sectional view of the solid-state battery module 1000 taken along the module side surface 1300 shown in FIG. 1. In the aspect shown in FIG. 2, two connection wirings 400 are disposed on the side surface of solid-state battery 100. More specifically, the solid-state battery module 1000 shown in the aspect of FIGS. 1 and 2 is provided with four connection wirings 400 in total.

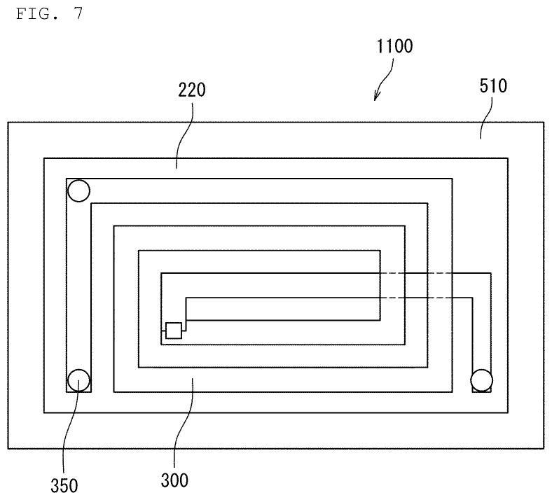

In an embodiment, the solid-state battery module may be provided with a U-shaped (or U-shaped) connection wiring. In other words, the solid-state battery module may be provided with a connection wiring with multiple bent parts. FIG. 8 is a sectional view schematically illustrating the configuration of a solid-state battery module according to an embodiment. FIG. 9 schematically shows a sectional view of the solid-state battery module of FIG. 8 taken along a side surface 1300. In the aspect shown in FIG. 9, two or more connection wirings are arranged for the solid-state battery module 1000. Specifically, a first connection wiring 410 and a second connection wiring 420 extend in a first direction from the first substrate 200A toward the coil part 300. Furthermore, a third connection wiring 430 that connects the first connection wiring 410 and the second connection wiring 420 is disposed. The third connection wiring 430 extends in a second direction that intersects with the first direction.

As shown in FIG. 9, the first connection wiring 410, the second connection wiring 420, and the third connection wiring 430 form a connection wiring whose appearance draws a U shape (or a U shape). In other words, the connection wiring with two bent parts is formed. The connection wiring that has such a form is provided so as to extend over the solid-state battery.

In the case of providing the connection wiring including the first, second, and third connection wirings on the first substrate, the first connection wiring and the second connection wiring can be positioned simultaneously on the first substrate. More specifically, instead of separately providing the first connection wiring and the second connection wiring on the first substrate, the first connection wiring and the second connection wiring are easily provided simultaneously on the first substrate, and thus, the solid-state battery module is more simply manufactured, and the manufacturing efficiency can be improved.

### (Water-Resistant Barrier Film)

In an embodiment, a water-resistant barrier film may be provided between the substrate and the solid-state battery. As shown in FIG. 1, a water-resistant barrier film 800 may be provided between the first substrate 200A and the solid-state battery 100, and/or the water-resistant barrier film 800 may be provided between the second substrate 200B and the solid-state battery 100. Providing the water-resistant barrier film 800 reduces undesirable permeation of water vapor in the external environment to the solid-state battery through the substrate, and thus, degradation of the solid-state battery characteristics can be reduced in a longer period of time.

In the aspect shown in FIG. 1, the water-resistant barrier film 800 is provided on, of the main surfaces of the first substrate 200A, the main surface on the proximal side with respect to the solid-state battery 100. Similarly, the water-resistant barrier film 800 is provided on, of the main surfaces of the second substrate, the main surface on the proximal side with respect to the solid-state battery. The water-resistant barrier films 800 provided on the first substrate 200A and the second substrate 200B are provided along the main surfaces of the respective substrates. The peripheral edge of the water-resistant barrier film 800 may have contact with the covering inorganic layer 520. In addition, the main surface of the water-resistant barrier film 800 is provided so as to have contact with the covering insulating layer 510. In the case of the aspect including the magnetic body layer 700 shown in FIGS. 3 and 4, the water-resistant barrier film 800 can be provided between the magnetic body layer 700 and the second substrate 200B.

The water-resistant barrier film is not particularly limited as long as the film is a material that exhibits an insulating property, specific examples of the material include inorganic insulators such as glass and alumina and organic insulators such as resins, and one of these insulators may be used alone, or two or more thereof may be used in combination.

Wireless power supply for the solid-state battery module according to the present disclosure will be described below.

The first substrate can include a wireless power supply circuit. The wireless power supply circuit can include a wiring, multiple electronic components, and the coil part provided inside the second substrate. Specifically, the wireless power supply circuit includes multiple circuits. For example, the wireless power supply circuit may include a power receiving circuit, a step-up/down circuit, and a battery charging circuit.

Power can be wirelessly transmitted from the outside (for example, a power transmitting unit) to the power receiving circuit. The power receiving circuit can include the coil part provided in the second substrate, a capacitor, a resistor, and a rectifier circuit. The coil part provided in the second substrate receives an electromagnetic wave from the outside, thereby generating an induced current.

The rectifier circuit rectifies the induced current generated in the coil part, and converts an alternating current into a direct current. The rectifier circuit may be a diode bridge circuit. A smoothing capacitor may be connected to the output of the rectifier circuit, and the output voltage output from the rectifier circuit can be smoothed.

The step-up/down circuit performs voltage conversion of an input voltage. The voltage rectified and then smoothed can be input to the step-up/down circuit. For the step-up/down circuit, for example, a DC-DC converter, a low dropout regulator (LDO), or the like may be used. A smoothing capacitor may be connected to the output of the step-up/down circuit, and the output voltage output from the step-up/down circuit can be smoothed. The smoothed output voltage of the step-up/down circuit is input to the battery charging circuit that performs charge control of the solid-state battery. The output voltage from battery charging circuit may be smoothed by a smoothing capacitor, and can be input to the solid-state battery to charge the solid-state battery.

The wireless power supply circuit may further include another circuit. The wireless power supply circuit may be provided with, for example, a wireless communication (wi-fi, Bluetooth, NFC, RF-ID, Zig-Bee, specified low power radio, and/or the like) circuit, a protection circuit, a current path circuit, a sensor circuit, and/or the like.

In an embodiment, the solid-state battery module may include a resonant circuit. In other words, the coil part and a capacitor provided on the first substrate may resonate with each other. Specifically, the capacitor and the coil part preferably resonate (that is, match) with each other at a predetermined frequency. The coil part and the capacitor may be connected in parallel. The receiving current can be increased by the resonance of the capacitor and the coil, and thus, the magnetic field from the outside can be more efficiently converted into an induced current, and the charging efficiency of the solid-state battery can be improved.

### [Method for Manufacturing Solid-State Battery Module]

The solid-state battery module according to the present disclosure can be obtained through a process of preparing a solid-state battery that includes battery constituent units including a positive electrode layer, a negative electrode layer, and a solid electrolyte between the electrodes and then modularizing the solid-state battery.

The manufacture of the solid-state battery according to the present disclosure can be roughly divided into: manufacture of a solid-state battery itself corresponding to a stage before modularization (hereinafter, referred to also s an “pre-module battery”); preparation of substrates; and modularization.

### <<Method for Manufacturing Pre-Module Battery>>

The pre-module battery can be manufactured in accordance with a printing method such as a screen printing method, a green sheet method in which a green sheet is used, or a combined method thereof. More particularly, the pre-module battery itself may be fabricated in accordance with a conventional method for manufacturing a solid-state battery (thus, for raw materials such as the solid electrolyte, organic binder, solvent, optional additives, positive electrode active material, and negative electrode active material described below, materials for use in the manufacture of known solid-state batteries may be used).

For better understanding of the present disclosure, one manufacturing method will be exemplified and described below, but the present disclosure is not limited to this method. In addition, the following time-dependent matters such as the order of descriptions are merely considered for convenience of explanation, and the present disclosure is not necessarily bound by the matters.

### (Formation of Stack Block)

The solid electrolyte, the organic binder, the solvent, and optional additives are mixed to prepare a slurry. Then, from the prepared slurry, sheets including the solid electrolyte are formed by firing.

The positive electrode active material, the solid electrolyte, the conductive material, the organic binder, the solvent, and optional additives are mixed to prepare a positive electrode paste. Similarly, the negative electrode active material, the solid electrolyte, the conductive material, the organic binder, the solvent, and optional additives are mixed to prepare a negative electrode paste.

The positive electrode paste is applied by printing onto the sheet, and a current collecting layer and/or a negative layer are applied by printing, if necessary. Similarly, the negative electrode paste is applied by printing onto the sheet, and a current collecting layer and/or a negative layer are applied by printing, if necessary.

The sheet with the positive electrode paste applied by printing and the sheet with the negative electrode paste applied by printing are alternately stacked to obtain a stacked body. Further, the outermost layer (the uppermost layer and/or the lowermost layer) of the stacked body may be the electrolyte layer, an insulating layer, or an electrode layer.

### (Formation of Fired Battery Body)

The stacked body is integrated by pressure bonding, and then cut into a predetermined size. The cut stacked body obtained is subjected to degreasing and firing. Thus, a fired laminated body is obtained. It is to be noted that the stacked body may be subjected to degreasing and firing before cutting the stacked body, and then cut.

### (Formation of End-Face Electrode)

The end-face electrode on the positive electrode side can be formed by applying a conductive paste to the positive electrode-exposed side surface of the fired laminated body. Similarly, the end-face electrode on the negative electrode side can be formed by applying a conductive paste to the negative electrode-exposed side surface of the fired laminated body. The end-face electrodes on the positive electrode side and the negative electrode side may be provided so as to extend to the main surface of the fired laminated body. The component for the end-face electrodes can be selected from at least one selected from silver, gold, platinum, aluminum, copper, tin, or nickel. Further, antimony, bismuth, indium, zinc, aluminum, and the like, which form an alloy with tin, may be contained.

Further, the end-face electrodes on the positive electrode side and the negative electrode side are not limited to being formed after firing the stacked body, and may be formed before firing and subjected to simultaneous firing.

Through the foregoing steps, a desired pre-module battery (corresponding to the solid-state battery 100) can be finally obtained.

### <<Preparation of Substrate>>

In this step, the substrates are prepared.

### (Preparation of First Substrate)

Although not particularly limited, in the case of using a resin substrate as the substrate, the substrate may be prepared by stacking multiple layers and then performing heating and pressurizing treatments for the layers. For example, a substrate precursor is formed with the use of a resin sheet made by impregnating a fiber cloth as a substrate with a resin raw material. After the formation of the substrate precursor, the substrate precursor is subjected to heating and pressurization with a press machine. In contrast, in the case of using a ceramic substrate as the substrate, for the preparation thereof, for example, multiple green sheets can be subjected to thermal compression bonding to form a green sheet laminate, and the green sheet laminate can be subjected to firing, thereby providing a ceramic substrate. The ceramic substrate can be prepared, for example, in accordance with the preparation of an LTCC substrate. The ceramic substrate may have vias and/or lands. In such a case, for example, holes may be formed in the green sheets with a punch press, a carbon dioxide laser, or the like, and may be filled with a conductive paste material, or precursors of for conductive parts such as vias or lands may be formed in accordance with a printing method or the like with the use of a conductive paste material or solder. Further, lands and the like can also be formed after firing the green sheet laminate.

Thereafter, multiple wirings are formed at predetermined intervals on the first main surface of the substrate for electrical connection. As described above, a desired substrate can be obtained.

### (Preparation of Second Substrate)

The method for preparing the second substrate is not particularly limited, but for example, the second substrate may be prepared in accordance with the same method as the method for preparing the first substrate. The coil inside the second substrate may be provided inside the second substrate by disposing a conductor material such as a wiring in a helical form or a spiral form. Specifically, the second substrate internally including the coil part may be prepared by forming a conductive paste material into a helical or spiral pattern on a substrate in accordance with a printing method or the like. The second substrate internally including the coil part may be a single product of a substrate with a conductive paste material formed in a helical or spiral pattern or a stack product of such substrates.

### <<Mounting of Electronic Component and the Like>>

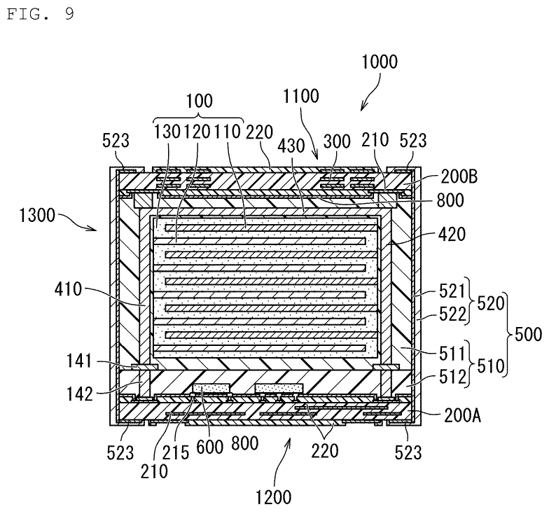

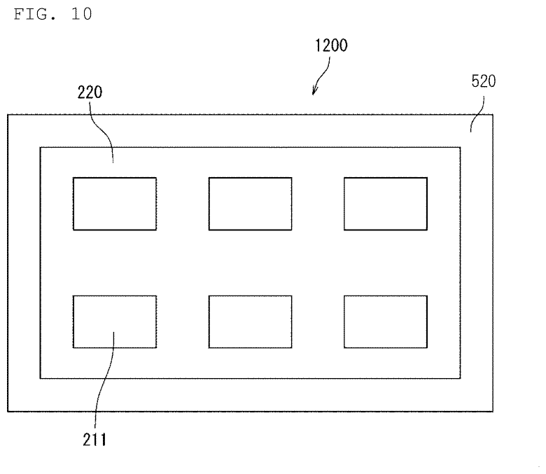

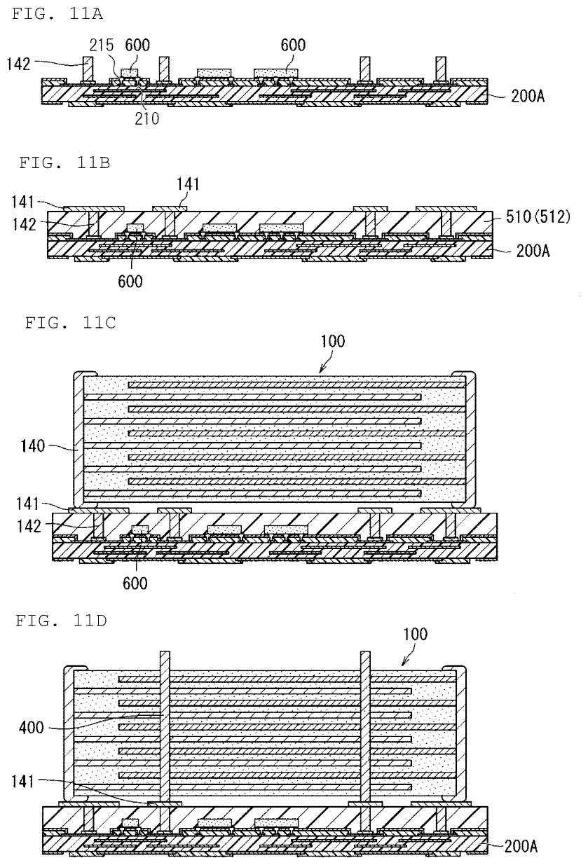

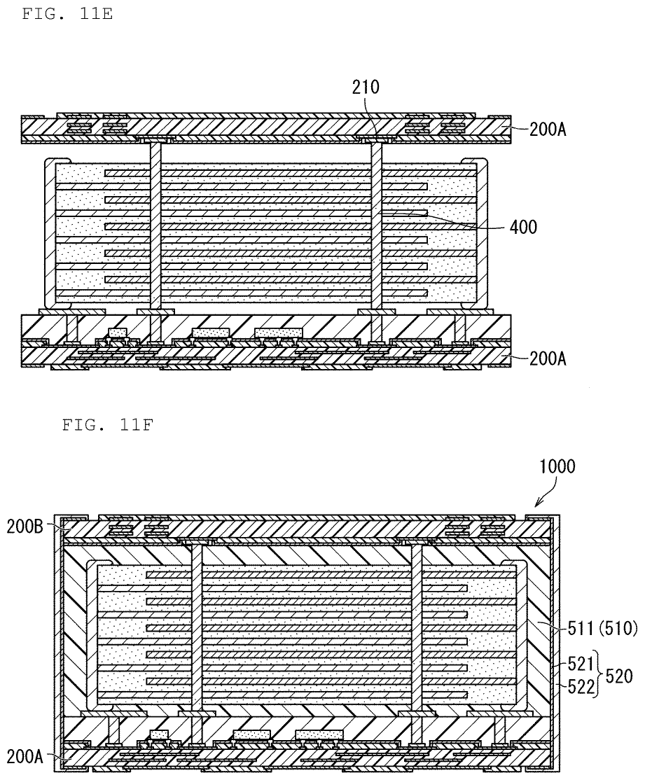

Next, at least the electronic components 600 such as a capacitor, the battery terminal connection pins 142, and the like are mounted on the wiring 210 located at predetermined positions of the first substrate 200A (see FIG. 11A). The wiring 210 located at predetermined positions of the first substrate 200A and the electronic components 600 may be fixed with the solder 215 or the like.

### <<Modularization>>

First, the covering part (for example, the electronic component sealing layer 512) is formed on the first substrate 200A with the electronic components 600, the battery terminal connection pins 142, and the like mounted. Specifically, a raw material for the covering insulating layer is provided such that the electronic components and the like are totally covered. When the covering insulating layer is made of a resin material, a resin precursor may be provided on the substrate and then subjected to curing or the like to mold the electronic component sealing layer. In forming the electronic component sealing layer, at least a part of the battery terminal connection pin 142 is exposed without being covered with the electronic component sealing layer. On the exposed battery terminal connection pins 142, conductive connection electrodes 141 are provided by printing (see FIG. 11B). Next, the solid-state battery 100 coated with end-face electrodes 140 (in particular, “non-modularized solid-state battery”) is mounted on the first substrate 200A such that the end-face electrode 140 and the connection electrode 141 are connected to each other (see FIG. 11C).

After the solid-state battery 100 is mounted on the first substrate 200A, the connection wirings 400 are connected to the connection electrodes 141 so as to extend over the solid-state battery 100 (see FIG. 11D). After the connection wirings 400 are connected, the second substrate 200B is disposed above the solid-state battery (see FIG. 11E). Specifically, the second substrate 200B is positioned above the solid-state battery, and the second substrate 200B and the connection wirings 400 are connected to each other. More specifically, the second substrate 200B is positioned above the solid-state battery such that the wiring 210 provided on the second substrate 200B is connected to the connection wirings 400.

After the wiring 210 of the second substrate and the connection wirings 400 are connected, a covering insulating layer (for example, the solid-state battery sealing layer 511) is formed (see FIG. 11F). Specifically, a raw material for the covering insulating layer is provided such that the solid-state battery 100 on the first substrate 200A is totally covered. When the covering insulating layer is made of a resin material, a resin precursor is provided on the substrate and then subjected to curing or the like to mold the covering insulating layer (for example, the solid-state battery sealing layer 511). In a preferred an aspect, the for example, the solid-state battery sealing layer may be molded through application of a pressure with a mold. By way of example only, a solid-state battery sealing layer for sealing the solid-state battery on the substrate may be molded through compression molding. As long as the material is a resin material for common use in molding, the form of the raw material for the solid-state battery sealing layer may be granular, and the type of the material may be thermoplastic. It is to be noted that such molding is not limited to die molding, and may be performed through polishing, laser processing, and/or chemical treatment. As described above, the solid-state battery is positioned between the first substrate and the second substrate.

After the formation of the covering insulating layer (for example, the solid-state battery sealing layer), the covering inorganic layer 520 is formed (see FIG. 11F). Specifically, the covering inorganic layer 520 (for example, the metal thin film 521) is formed on the “covering precursor with the solid-state battery covered with the solid-state battery sealing layer on the first substrate”. For the metal thin film 521, for example, dry plating may be performed to form a dry-plating film as the metal thin film. More specifically, dry plating is performed to form a metal thin film on the exposed surfaces of the respective side surfaces of the covering precursor as well as of the first substrate and the second substrate (that is, excluding the bottom surface of the first substrate and the top surface of the second substrate). After the formation of the metal thin film, the metal plating layer 522 is formed outside the metal thin film 521 (see FIG. 11F). Specifically, the metal plating layer 522 is formed so as to cover the metal thin film 521. The metal plating layer 522 may be formed by performing wet plating. More specifically, wet plating is performed to form a metal plating layer, so as to cover the metal thin film covering the respective side surfaces of the covering precursor as well as of the first substrate and the second substrate. Furthermore, the metal plating layer may be formed so as to cover a part of the bottom surface of the first substrate and/or the top surface of the second substrate. Specifically, the metal plating layer may be formed so as to cover the peripheral edge of the bottom surface of the first substrate and/or the peripheral edge of the top surface of the second substrate.

Further, a magnetic body layer may be provided from the viewpoint of making the coil provided inside the second substrate more likely to receive a magnetic field from the outside. The magnetic body layer can be obtained, for example, by rolling a mixture of a magnetic powder and a resin to an arbitrary thickness and forming the mixture into a plate shape. In addition, the magnetic body layer can be also cut into an arbitrary size.

The magnetic body layer obtained in accordance with the method mentioned above can be provided, for example, in the step of disposing the second substrate above the solid-state battery. Specifically, the magnetic body layer cut into an arbitrary size may be provided on the second substrate, and the second substrate provided with the magnetic body layer may be disposed above the solid-state battery. For example, the second substrate provided with the magnetic body layer may be disposed above the solid-state battery such that the magnetic layer disposed on the second substrate and the solid-state battery face each other. As a method for providing the magnetic body layer on the second substrate, the magnetic body layer may be attached to the second substrate with the use of an adhesive or the like.

Through the steps described above, a module product in which the solid-state battery on the substrate is covered with the covering part can be obtained. More particularly, the “solid-state battery module” according to the present disclosure can be finally obtained. The solid-state battery module obtained through such steps has the coil part provided inside the second substrate, and thus, the total size of the solid-state battery module and the coil part are likely to be relatively small. In addition, the position of the coil part is easily fixed, and thus, the inductance value of the coil part is easily stabilized, and matching for each solid-state battery module can be reduced. Accordingly, wireless power supply and the like can be efficiently performed.

Although the embodiments of the present disclosure have been described above, typical examples have been only illustrated. Accordingly, the present disclosure is not limited to the embodiments, and those skilled in the art will readily understand that various aspects can be conceived.

Aspects of the solid-state battery module according to the present disclosure are as follows.

<1> A solid-state battery module including: a first substrate with a wiring; a solid-state battery on the first substrate; and a second substrate on an opposite side of the solid-state battery relative to the first substrate and internally including a coil part that is electrically connectable to the first substrate, where a main surface of the second substrate defines a module top surface or is inside the module top surface.

<2> The solid-state battery module according to <1>, further comprising a magnetic body layer between the solid-state battery and the second substrate.

<3> The solid-state battery module according to <2>, in which the magnetic body layer is adjacent to a side of the second substrate relative to the solid-state battery.

<4> The solid-state battery module according to <2> or <3>, in which the magnetic body layer is in contact with the second substrate.

<5> The solid-state battery module according to any one of <2> to <4>, in which the coil part is inside the planar contour of the magnetic body layer.

<6> The solid-state battery module according to any one of <2> to <5>, further including a covering part that covers the solid-state battery, where the covering part includes a covering insulating layer and a covering inorganic layer located outside the covering insulating layer, and the planar contour of the magnetic body layer is surrounded by the covering inorganic layer.

<7> The solid-state battery module according to <6>, in which the outer contour of the magnetic body layer is located on the inner contour of the covering inorganic layer or inside the inner contour in a sectional view of the solid-state battery module.

<8> The solid-state battery module according to any one of <2> to <7>, in which the solid-state battery includes an electrode layer, and the thickness of the magnetic body layer is larger than the thickness of the electrode layer of the solid-state battery.

<9> The solid-state battery module according to any one of <2> to <8>, in which the magnetic body layer is a layer constructed to attract a magnetic field to the coil part.

<10> The solid-state battery module according to any one of <2> to <9>, in which the magnetic body layer is a layer constructed to keep a magnetic field from being adsorbed by a metal side.

<11> The solid-state battery module according to any one of <1> to <5>, further including a covering part that covers the solid-state battery, where the covering part includes a covering insulating layer and a covering inorganic layer located outside the covering insulating layer, and includes a discontinuous region of the covering inorganic layer on a side of the module top surface.

<12> The solid-state battery module according to <11>, in which the covering inorganic layer constitutes at least a module side surface part.

<13> The solid-state battery module according to <11> or <12>, in which the covering inorganic layer further constitutes a part of at least one of the module top surface and module bottom surface that are continuous with the module side surface part.

<14> The solid-state battery module according to any one of <11> to <13>, in which the covering inorganic layer covers at least a side surface of the second substrate.

<15> The solid-state battery module according to any one of <11> to <14>, in which the covering inorganic layer further covers a part of the upper main surface of the second substrate that is continuous with the side surface of the second substrate.

<16> The solid-state battery module according to any one of <1> to <15>, further including a connection wiring that connects the first substrate and the coil part.

<17> The solid-state battery module according to <16>, further comprising: first and second connection wirings that extend in a first direction from the first substrate toward the coil part; and a third connection wiring that connects the first and second connection wirings, the third connection wiring extending in a second direction that intersects with the first direction.

<18> The solid-state battery module according to <16> or <17>, further comprising an electronic component mounted on a main surface of the first substrate, and the coil part and the electronic component are electrically connected via the connection wiring.

<19> The solid-state battery module according to any one of <16> to <18>, in which the coil part and the solid-state battery are electrically connected via the connection wiring.

The solid-state battery module according to the present disclosure can be used in various fields where battery use or power storage is assumed. By way of example only, the solid-state battery module according to the present disclosure can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home energy storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

100: Solid-state battery
110: Positive electrode layer
120: Negative electrode layer
130: Solid electrolyte
140: End-face electrode
141: Connection electrode
142: Battery terminal connection pin
200A: First substrate
200B: Second substrate
210: Wiring
211: Back surface pad
215: Solder
220: Resist layer
300: Coil part
350: Connection pin
400: Connection wiring
410: First connection wiring
420: Second connection wiring
430: Third connection wiring
450: Antenna circuit connection pin
500: Covering part
510: Covering insulating layer
511: Solid-state battery sealing layer
512: Electronic component sealing layer
520: Covering inorganic layer
521: Metal thin film
522: Metal plating layer
523: Metal pad
600: Electronic component
700: Magnetic body layer
800: Water-resistant barrier film
1000: Solid-state battery module
1100: Top surface of solid-state battery module
1200: Bottom surface of solid-state battery module
1300: Side surface of solid-state battery module

1. A solid-state battery module comprising:
a first substrate with a wiring;
a solid-state battery on the first substrate; and
a second substrate on an opposite side of the solid-state battery relative to the first substrate and internally including a coil part that is electrically connectable to the first substrate,
wherein a main surface of the second substrate defines a module top surface or is inside the module top surface.

2. The solid-state battery module according to claim 1, further comprising a magnetic body layer between the solid-state battery and the second substrate.

3. The solid-state battery module according to claim 2, wherein the magnetic body layer is adjacent to a side of the second substrate relative to the solid-state battery.

4. The solid-state battery module according to claim 2, wherein the magnetic body layer is in contact with the second substrate.

5. The solid-state battery module according to claim 2, wherein the coil part is inside a planar contour of the magnetic body layer.

6. The solid-state battery module according to claim 2, further comprising a covering part that covers the solid-state battery,
wherein the covering part includes a covering insulating layer and a covering inorganic layer located outside the covering insulating layer, and a planar contour of the magnetic body layer is surrounded by the covering inorganic layer.

7. The solid-state battery module according to 6, wherein an outer contour of the magnetic body layer is located on an inner contour of the covering inorganic layer or inside the inner contour in a sectional view of the solid-state battery module.

8. The solid-state battery module according to claim 2, wherein the solid-state battery includes an electrode layer, and a thickness of the magnetic body layer is larger than a thickness of the electrode layer of the solid-state battery.

9. The solid-state battery module according to claim 2, wherein the magnetic body layer is a layer constructed to attract a magnetic field to the coil part.

10. The solid-state battery module according to claim 2, wherein the magnetic body layer is a layer constructed to keep a magnetic field from being adsorbed by a metal side.

11. The solid-state battery module according to claim 1, further comprising a covering part that covers the solid-state battery,
wherein the covering part includes a covering insulating layer and a covering inorganic layer located outside the covering insulating layer, and includes a discontinuous region of the covering inorganic layer on a side of the module top surface.

12. The solid-state battery module according to claim 11, wherein the covering inorganic layer constitutes at least a module side surface part.

13. The solid-state battery module according to claim 12, wherein the covering inorganic layer further constitutes a part of at least one of the module top surface and a module bottom surface that are continuous with the module side surface part.

14. The solid-state battery module according to claim 11, wherein the covering inorganic layer covers at least a side surface of the second substrate.

15. The solid-state battery module according to claim 11, wherein the covering inorganic layer further covers a part of an upper main surface of the second substrate that is continuous with the side surface of the second substrate.

16. The solid-state battery module according to claim 1, further comprising a connection wiring that connects the first substrate and the coil part.

17. The solid-state battery module according to claim 1, further comprising:
first and second connection wirings that extend in a first direction from the first substrate toward the coil part; and
a third connection wiring that connects the first and second connection wirings, the third connection wiring extending in a second direction that intersects with the first direction.

18. The solid-state battery module according to claim 16, further comprising an electronic component mounted on a main surface of the first substrate, and the coil part and the electronic component are electrically connected via the connection wiring.

19. The solid-state battery module according to claim 16, wherein the coil part and the solid-state battery are electrically connected via the connection wiring.
